(19) United States
(12) Patent Application Publication
(10) Pub. No.: US 2009/0242588 A1
(43) Pub. Date: Oct. 1, 2009

(54) SQUEEZE BOTTLE AND PUMP COMBINATION

(76) Inventor: Holly Olson, Mansfield, OH (US)

Correspondence Address: HOWARD M COHN;PATENT ATTORNEY LLC, 21625 CHAGRIN BLVD #220, CLEVELAND, OH, 44122, US

(21) Appl. No.: 12/401,937

(22) Filed: Mar. 11, 2009

Related U.S. Application Data
(60) Provisional application No. 61/040,761, filed on Mar. 31, 2008.

(51) Int. Cl. G01F 11/00

(52) U.S. Cl. 222/331

(57) ABSTRACT

A flexible squeeze bottle for containing and dispensing a viscous liquid has a dispenser pump device at one end of the bottle. The pump device consists of a cap, a plunger operator, a hollow tube and a pump rod. The hollow tube is disposed within the flexible bottle for pumping the viscous liquid within the bottle though an outlet opening in the plunger operator for selectively dispensing the viscous liquid therefrom. Another dispensing device, provided at an opposite end of the bottle, includes a closed and sealed opening. The closed and sealed opening is manually openable and closable by the user for selectively dispensing the viscous liquid within the squeeze bottle therefrom.

### CROSS-REFERENCE TO RELATED APPLICATIONS

This application claims the benefit of U.S. Provisional Patent Application No. 61/040,761 filed on Mar. 31, 2008, which is incorporated herein by reference.

### TECHNICAL FIELD OF THE INVENTION

The present invention relates generally to a bottle specifically designed to entirely dispense the liquid contents housed therein, and more particularly to a squeeze bottle having a dispensing pump at an upper end and a bottom dispenser on the lower end.

### BACKGROUND OF THE INVENTION

The present invention relates to a bottle specifically designed to entirely dispense the liquid contents housed therein, especially when such liquids are that of a viscous, slow-flow nature. Generally, such bottles are commonly used to dispense viscous liquid contents such as catsup, mustard, shampoo, lotion, conditioners, etc. and such bottles usually contain an opening which is provided at one end. The contents of these bottles may be either pumped out with a pump, or squeezed out by the user squeezing the bottle. When the contents of such bottles have been partially consumed, it is necessary for the user to shake the bottle several times in its upside-down position until the contents reach the opening. This process becomes more time consuming and frustrating when the bottle is nearly empty. In fact, it is nearly impossible to completely empty such pump bottles unless the user is willing to balance the bottle upside down on its lid and wait for several minutes or longer for the contents to gravitate to the opening.

U.S. Pat. No. 4,618,076 to Silvenis discloses for example “A dual dispensing bottle includes two upwardly extending necks having a trigger sprayer attached to one neck and a frangible orifice creating section integrally formed in the other neck. The frangible section is easily removed by twisting and doubles as a plug for the created orifice. The frangible twist-off section enables the consumer to dispense a large amount of product independently of and without removing the trigger sprayer.” This concept uses two necks so that a liquid to be either sprayed or poured. It is, however, not at all suitable for a viscous material.

U.S. Pat. No. 5,141,136 to Tignor discloses for example “a container having top and bottom access openings where the structure of the container facilitates dispensing the contained materials conveniently and positively especially when the main body of the contained materials have been dispensed and residual material remains.” There is not, however, a teaching or suggestion of using a dispensing pump to dispense the contents of the container. A dispensing pump provides a unique advantage because it enables the user to remove the contents without squeezing the bottle. Instead the container can remain in an upright position. This allows for bottles of any shape and any material. Also, the known amount can be dispensed each time, for example if the pump is fully compressed.

U.S. Pat. No. 5,421,488 to Ehrbar discloses for example “A squeeze bottle for dispensing viscous liquids of the type having a conventional opening and associated flip lid at the top thereof is provided with a second opening and associated flip lid positioned adjacent the bottom of the squeeze bottle so that the contents remaining when the bottle is nearly empty may be easily dispensed therefrom. Alternatively, the conventional top opening and flip lid may be eliminated and a single opening provided adjacent the bottom of the squeeze bottle. In another embodiment, a squeeze bottle is symmetrically configured to have flip lids of sufficient surface area at each end thereof to permit storage of the squeeze bottle on either end so that the contents may be easily dispensed from the flip lid on which the squeeze bottle rests during storage. Again, there is not a teaching or suggestion of using a dispensing pump to dispense the contents of the container to take advantage of the unique improvement that enables the user to remove the contents without squeezing the bottle, allowing the container to remain in an upright position during use, to enable the forming of the bottles of any shape and even any material and to be able to dispense a known amount each time.

U.S. Pat. No. 5,482,172 to Braddock discloses for example “A container with dual dispensers for allowing easy and complete dispensing of the container contents from either end of the container. In a first embodiment the container is characterized by a receptacle provided with a top dispenser on the upper end and a bottom dispenser on the lower end. The dispensers each include a pivoting lid or spout which reversibly seals a dispensing hole provided on the corresponding top or bottom surface of the container. In a second embodiment the top dispenser is characterized by a pivoting lid hinged at substantially the midpoint of the container top surface. In a third embodiment the top dispenser includes a spout pivoted to the top surface of the container and in a fourth embodiment the top dispenser is characterized by a threadably-mounted closure which pivotally carries a lid for reversibly sealing a dispensing hole in the top surface of the closure. In another embodiment the container is provided with both top and bottom dispensers, each having a pivoting lid which is recessed in the corresponding end of the container and is pivoted open into dispensing configuration by applying pressure to one end of the lid.” Here to, there is no contemplation of using a dispensing pump to dispense the contents of the container to take advantage of the unique improvement that enables the user to remove the contents without squeezing the bottle, allowing the container to remain in an upright position during use, to enable the forming of the bottles of any shape and even any material and to be able to dispense a known amount each time.

The current invention seeks to rectify the aforementioned problem, and to provide a container with a top dispenser on the upper end and a bottom dispenser on the lower end. The top dispenser is a dispensing pump to remove the contents without the need to squeeze the bottle, to allow the container to remain in an upright position during use, to enable the forming of the bottles of any shape and even material and to be able to dispense the same amount each time.

### ASPECTS AND SUMMARY OF THE INVENTION

It is an aspect of the present invention to provide a container with a top dispenser on the upper end and a bottom dispenser on the lower end.

It is another aspect of the present invention to provide a container wherein the top dispenser is a dispensing pump to remove the contents without the need to squeeze the container.

It is yet another aspect of the present invention to provide a container with a top dispenser and bottom dispenser that allows the container to remain in an upright position during use.

It is still another aspect of the present invention to provide a container with a top dispenser and bottom dispenser that allows the containers to be of any shape and even material.

It is another aspect of the present invention to provide a container with a top dispenser and bottom dispenser that allows the user to dispense the same amount of the contents of the container each time.

According to the present invention there has been disclosed a squeeze bottle for containing and dispensing a viscous liquid. The squeeze bottle includes a flexible body. A dispenser pump device is attached at one end of the flexible body. The dispensing pump includes a cap, a plunger operator and a hollow tube. The hollow tube is disposed within the flexible body for pumping the viscous liquid within the body though an outlet opening in the plunger operator for selectively dispensing the viscous liquid therefrom. A second dispensing structure is at an opposite end of the flexible body. The second dispensing structure includes a closed and sealed opening. The closed and sealed opening can be manually opened and closed by the user for selectively dispensing the viscous liquid within the squeeze bottle.

Further according to the present invention, the squeeze bottle includes at least a partially flat bottom surface on which the bottle rests when in a typical operating or a storage position.

Still further according to the present invention, the squeeze bottle is constructed of flexible material, such as for example plastic.

Yet further according to the present invention, the viscous liquid is dispensed quickly or slowly from the squeeze bottle according to the speed that the pump operator of the dispenser pump is operated or the amount squeezed.

Moreover, further according to the present invention, the amount of viscous liquid being dispensed is controlled by the predetermined distance the plunger is pressed towards the flexible bottle.

Also according to the present invention, the second dispensing structure at an opposite end of the flexible body includes an opening sealed closed with a plug.

Further according to the present invention, the second dispensing structure at an opposite end of the flexible body includes an opening sealed closed with a stopper. The stopper is secured within the opening by structure components that firmly grip onto the opening.

Still further according to the present invention, the structure that firmly grips onto the opening of the second dispensing structure includes projections that extend outward from the stopper and beyond the edge of the opening.

Also according to the present invention, the stopper is attached to an arm-like section connected to the outside surface of the opposite end of the flexible body.

Yet further according to the present invention, the second dispensing structure includes a small opening through the base end of the bottle and a cupped shaped closure having an opening there through and that fits over the outer surface of bottle and is mounted thereto.

Still further according to the present invention, the cup shaped closure is mounted to the bottom of the bottle so as to be able to turn in a clockwise or counter clockwise direction whereby the opening through the cup shaped closure aligns with the opening at the bottom end of the flexible body of the bottle so that the remaining contents in the bottle can be squeezed through the aligned openings.

Also according to the present invention, the second dispensing structure includes a small opening through the base end of the bottle. The small opening is sealed closed with a removable plug attached to a closure lid. The closure lid can include an upstanding lip which can be secured to the base end of the bottle by friction. The closure lid swings away on a hinge secured to the base end so that the plug is removed from the small opening through the base end of the bottle.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

FIG. 1 is an orthogonal view of the plastic squeeze bottle with a pump dispenser, with a pump on top and opening on the bottom, in accordance with the present invention.

FIG. 2 is a view through lines 2-2 of FIG. 1 showing bottom view of the bottle and the stopper adapted for closing and sealing the bottom opening of the squeeze bottle, in accordance with the present invention.

FIG. 3 is an orthogonal view of an alternative embodiment of the plastic squeeze bottle with a pump dispenser on the top of the bottle and an opening through the bottom, in accordance with the present invention.

FIG. 4 is a bottom view of the alternative embodiment through the lines 4-4 of FIG. 3, in accordance with the present invention.

FIG. 5 is an orthogonal view of an alternative embodiment of the plastic squeeze bottle with a pump dispenser, with a dispensing pump on top (not shown) of the bottle and a closed and sealed opening through the bottom bottle, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

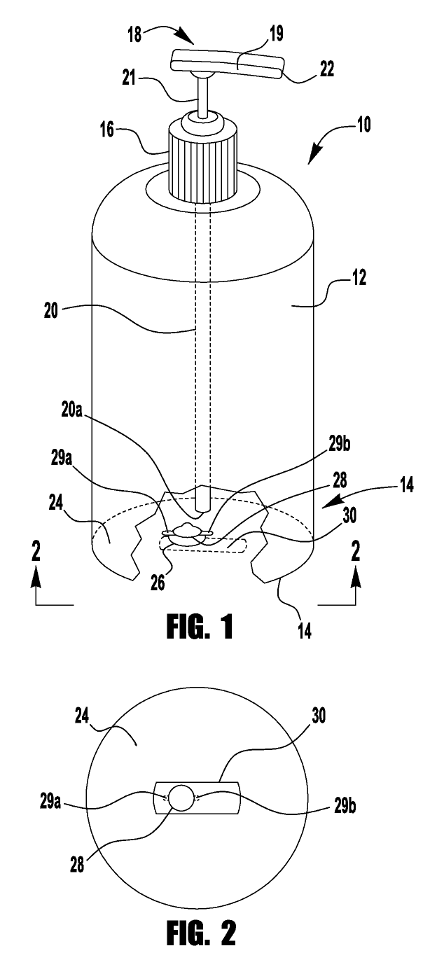

Referring now to FIG. 1, there is shown a squeeze bottle 10 of the type that may be used for containing and dispensing a viscous liquid such as for example, hand lotion or ketchup. Bottle 10 is preferably a flexible squeeze bottle 10 and may be constructed of various forms and types of flexible material such as for example plastic, nylon, synthetic rubber, and polyethylene. Bottle 10 includes a shaped body 12, including a top end with an opening, typically through a neck (not shown) and a bottom end 14 on which bottle 10 rests when in a typical operating or a storage position. Being that the contents of bottle 10 are primarily dispensed with a conventional pump dispenser, the bottle can be of any desired shape. An end cap 16, supporting an associated conventional pump dispenser 18, is attached by conventional means, such as by internal threads to external threads of the projecting neck forming a top opening of the bottle 10.

An aspect of the invention is that the contents of the bottle 10 can be dispensed as quickly or as slowly as desired by simply pushing down on the plunger or pump operator 19 of the dispenser pump 18 at a rate that dispenses the amount of the contents as desired. Also, it is within the terms of the present invention to control the exact amount of the contents being dispensed by pressing the plunger 19 of the pump 18, a predetermined amount, such as, until it contacts the end cap 16. The amount of contents being withdrawn from the body 12 through a hollow tube 20, which in turn is connected to the hollow pump rod 21, and dispensed through the plunger 19 can also be controlled by the length of the stroke. Any type of conventional dispenser pump can be substituted for pump dispenser 18.

A second opening 26, closed and sealed by a conventional stopper, is provided through the bottom surface 24 at the bottom end 14 of the body 12 of bottle 10 to permit the user to dispense the viscous contents there-from. By providing the closed and sealed opening 26 on the bottom of squeeze bottle 10, the user may easily dispense the viscous contents that remains in bottle 10 when it is nearly empty and the dispenser pump 18 cannot dispense the remaining contents within the bottle because the end of the tube 20 does not reach the bottom surface 24 of the bottle.

An advantage of the present invention is that the contents of the bottle 10 can be dispensed from the opening at the bottom end of the bottle without the need for removing the dispensing pump. Further, since the bottle is sitting on the flat bottom surface 24 when the contents are being dispensed from the pump, the contents naturally collect at the bottom of the bottle 12. Accordingly, it is not necessary to shake the bottle in its upside down position in order to dispense from the opening 26.

Referring again to FIG. 1, standard dispensing pump 18 consists of a cap 16, a plunger or pump operator 19, a hollow tube 20 open at one end to the contents of the bottle and a hollow pump rod 21 connecting the plunger 19 to the hollow tube 20. The pump operator 19 is mounted to the plunger 21 and has a hollow passageway extending there through and an outlet opening 22 from which the contents of the bottle are dispersed. When the user depresses plunger 19 of standard pump 18, the viscous contents within bottle 12 rises through the hollow tube 20 and is dispensed from the opening 22 of plunger 19. Typically, the bottom end 20a of tube 20 extends close to but not to the bottom base 24 of bottle 12. If bottom end 20a of tube 20 were to contact the bottom base 24, the viscous contents could not be able to readily enter the tube 20.

There can be an opening or outlet 26 through the bottom surface 24 of the bottom end 14 of the bottle. Preferably, the opening 26 extends through the center of bottom surface 24. Bottom surface 24 may be concave to accommodate stopper 28, as described below. When the tube 20 is no longer in contact with the contents of the bottle, such as the liquid or cream remaining in the bottom portion of bottle 12 after the pump is no longer dispensing the contents, the user may squeeze the bottle 12, and the remaining contents are dispensed out of bottle 12 through opening 26.

While there is still sufficient viscous contents in the bottle 12 for the dispensing pump 18 to be utilized, opening 26 is sealed closed with a stopper or plug 28, as illustrated in FIGS. 1 and 2. Stopper 28 is secured within opening 26 to prevent leakage through opening 26. The stopper can be secured by any conventional means, such as with ear-like projections 29a and 29b. Projections 29a and 29b firmly grip onto opening 26, until the user wishes to utilize opening 26, and then stopper 28 can be removed to open opening 26. Stopper 28 can be attached to arm-like section 30, made of plastic or other suitable material, which is connected to the outside of bottom surface 24. When the user wishes to squeeze bottle 12, arm-like section 30 is swung away to allow the user to remove stopper 28, and then the stopper is reinserted to close and seal opening 26 when finished.

FIG. 2 illustrates a bottom view of bottom surface 24. Hinge-like section 30 is shown, with stopper 28, and projections 29a and 29b (in phantom), as described above.

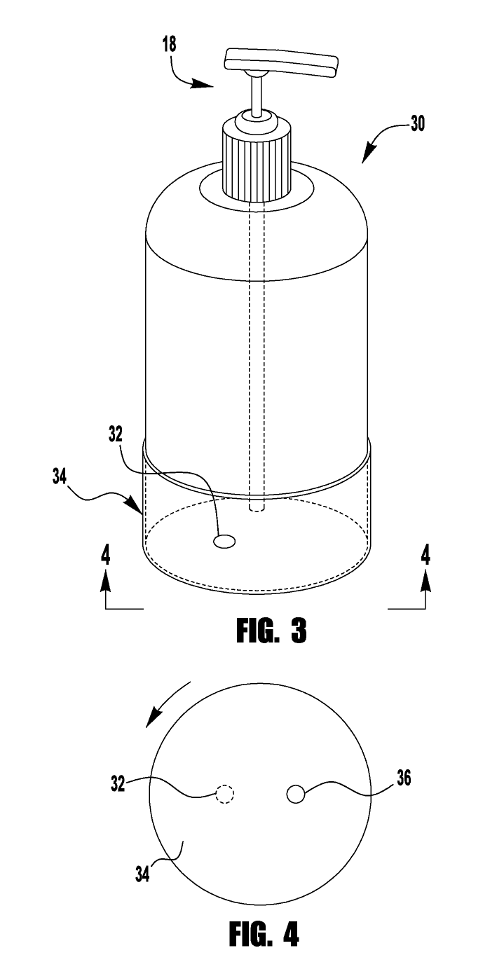

FIG. 3 illustrates an orthogonal view of the alternative embodiment of plastic squeeze bottle 30 with a pump dispenser 18. The bottle 30 and the pump dispenser 18 are substantially identical to flexible squeeze bottle with a pump dispenser 10 of FIG. 1, except for the base structure. In this embodiment, the base end of the bottle 30 closes the bottle and has a small opening 32 there through. Joined to the bottle 30 is cupped shaped closure 34 that fits over the outer surface of bottle 30 and is mounted thereto so that it is not easily removable. The closure 34 is mounted to the bottle so as to turn in a clockwise or counter clockwise direction. There is a hole 36 within closure 34. When the user wishes to squeeze the liquid through opening 36, he/she can turn cupped shaped closure 34 until hole 36 aligns with opening 32 of bottle 30, see FIG. 4. Then, when the user is finished, he/she may simply turn cupped shaped closure 34 until opening 36 is no longer aligned with hole 32 and is sealed closed.

FIG. 4 illustrates cupped shaped closure 34 with opening or hole 36. Also shown is opening 32 of bottle 30.

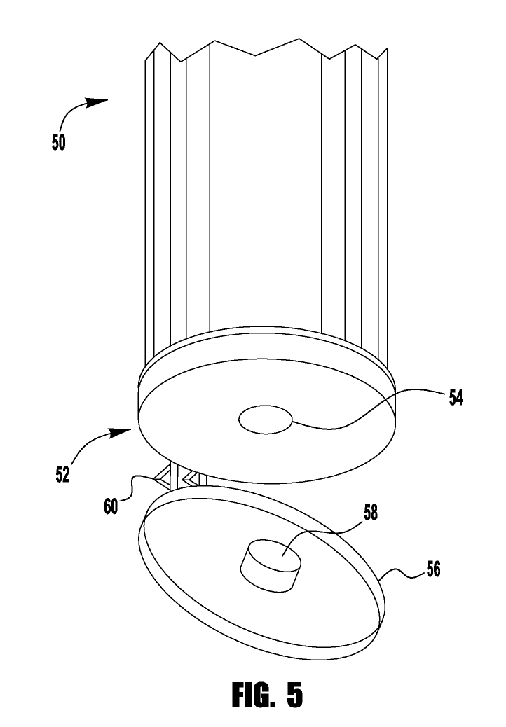

Referring to FIG. 5, there is illustrated an alternative embodiment of plastic squeeze bottle with a pump dispenser 50. The bottle and its components are identical to plastic squeeze bottle with a pump dispenser 10, except for the base mechanism. In this embodiment, a second opening 54, closed by a conventional plug 58, is provided through the bottom portion 52 of the dispenser 50 to permit the user to dispense the viscous contents therefrom. By providing the opening through the bottom portion 52 of squeeze bottle 50, the user may easily dispense the viscous contents that remain in bottle 50 when it is nearly empty, without the need for removing the pump and shaking the bottle in its upside down position in order to dispense from the opening. As with the other embodiments, since the squeeze bottle 50 rests on its bottom portion 52 when being stored, any viscous contents remaining when squeeze bottle 50 is nearly empty will gravitate to the bottom thereof.

There is an opening or outlet 54 in the center of bottom portion 52. Bottom portion 52 may be flat or concave. While there is still sufficient viscous contents in the bottle 50 for the pump (not shown) to be utilized, opening 54 is sealed closed with a removable stopper or plug 58. The plug 58 is attached to a closure lid 56 made of plastic or other suitable material, which is connected by hinge 60 to the outside section of bottom portion 52 and is operable to close and seal the opening 54. The closure lid 56 can include an upstanding circular lip 56a which can be secured to the bottom portion 52 by friction. While a circular lip is shown, it is within the terms of the invention to use a lip of any desired shape that conforms to the shape of the bottom portion 52. When the user wishes to squeeze bottle 50 and dispense the contents from opening 54, the closure lid 56 swings away on the hinge 60 from the bottom portion so that the plug 58 is removed from the opening 54. Then, the opening 54 can be closed and sealed with the plug 58 when finished.

While the present invention contemplates using the pump dispenser until the contents of the container are nearly emptied and then squeezing the container to dispense the remaining contents, it is also within the terms of the invention to sometimes, for example, to use the pump to dispense a set amount and sometimes to squeeze the container to dispense a large amount of the contents.

It is also understood, of course, that while the form of the invention herein shown and described constitutes a preferred embodiment of the invention, it is not intended to illustrate all possible forms thereof. It will also be understood that the words used are words of description rather than limitation, and that various changes may be made without departing from the spirit and scope of the invention disclosed. Thus, the scope of the invention should be determined by the appended claims and their legal equivalents, rather than solely by the examples given.

1. A squeeze bottle for containing and dispensing a viscous liquid, the squeeze bottle comprising:
a flexible body;
dispenser pump means at one end of the flexible body, said dispenser pump means including a pump consisting of a cap, a plunger operator, a hollow pump rod and a hollow tube, the hollow tube being disposed within the flexible body for pumping the viscous liquid within the body though an outlet opening in the plunger operator for selectively dispensing the viscous liquid therefrom;
a second dispensing means at an opposite end of the flexible body, said second dispensing means including a closed and sealed opening, the closed and sealed opening being manually openable and closable for selectively dispensing the viscous liquid within the squeeze bottle therefrom.

2. The squeeze bottle of claim 1 wherein the squeeze bottle includes at least a partially flat bottom surface on which bottle rests when in a typical operating or a storage position.

3. The squeeze bottle of claim 1 wherein the squeeze bottle is constructed of any flexible material from the group comprising plastic, nylon, synthetic rubber, and polyethylene.

4. The squeeze bottle of claim 1 wherein the viscous liquid is dispensed quickly or slowly according to the speed that the plunger operator of the dispenser pump is operated.

5. The squeeze bottle of claim 1 wherein the amount of viscous liquid being dispensed is controlled by the predetermined distance the plunger operator is pressed towards the flexible bottle.

6. The squeeze bottle of claim 1 wherein the second dispensing means at an opposite end of the flexible body includes an opening that is sealed closed with a plug.

7. The squeeze bottle of claim 6 wherein the second dispensing means at an opposite end of the flexible body includes an opening that is sealed closed with a stopper, the stopper being secured within the opening by means that firmly grip onto the opening.

8. The squeeze bottle of claim 7 wherein the means that firmly grip onto the opening of the second dispensing means includes ear-like projections extending outward from the stopper and beyond the edge of the opening when the stopper is inserted into the opening.

9. The squeeze bottle of claim 8 wherein the stopper is attached to an arm-like section connected to the outside surface of the flexible body.

10. The squeeze bottle of claim 8 wherein:
the second dispensing means includes a small opening through the base end of the bottle; and
a cupped shaped closure having an opening there through fits over the outer surface of bottle and is mounted thereto.

11. The squeeze bottle of claim 10 wherein the cup shaped closure is mounted to the bottom of the bottle so as to turn in a clockwise or counter clockwise direction whereby the opening through the cup shaped closure aligns with the opening of the bottle whereby the remaining contents in the bottle can be squeezed through the aligned holes.

12. The squeeze bottle of claim 8 wherein:
the second dispensing means includes a small opening through the bottom end of the bottle; and
the small opening is sealed closed with a removable plug attached to a closure lid.

13. The squeeze bottle of claim 12 wherein:
the closure lid can include an upstanding lip which can be secured to the bottom end of the bottle by friction.

14. The squeeze bottle of claim 13 wherein the closure lid swings away on the hinge secured to the bottom end so that the plug is removed from the small opening through the bottom end of the bottle.

15. The squeeze bottle of claim 1 wherein the flexible body has a cylindrical shape.
